(19) United States
(12) Patent Application Publication
(10) Pub. No.: US 2013/0070082 A1
(43) Pub. Date: Mar. 21, 2013

(54) WIRELESS VEHICLE AUDIO/VIDEO SYSTEM

(71) Applicant: Shih-Yao CHEN, New Taipei City (TW)

(72) Inventor: Shih-Yao CHEN, New Taipei City (TW)

(21) Appl. No.: 13/234,412

(22) Filed: Sep. 16, 2011

(51) Int. Cl. H04N 7/18; H04N 7/00

(52) U.S. Cl. 348/118; 348/552; 348/E07.085; 348/E07.091

(57) ABSTRACT

A wireless vehicle audio/video system includes a head unit installed in a car and having built therein a first wireless communication module and a multimedia processing device for processing audio/video and image data from different sources, a wireless car speaker system, and one or a number of tablet computers operable to provide a command to the head unit wirelessly for driving the multimedia processing device of the head unit to run an audio-video data for enabling the generated image data to be transmitted wirelessly to the touch screen of each tablet computer for playing and the generated audio signal to be outputted through the car speaker system.

### BACKGROUND OF THE INVENTION

1. Field of the Invention

The present invention relates to vehicle audio/video technology and more particularly, to a wireless vehicle audio/video system, which consists of a head unit and multiple tablet computers.

2. Description of the Related Art

Conventional vehicle audio/video playback systems, such as DVD or DVB-T/ATSC/CMMB systems generally comprise a head unit and one or multiple display panels. Each display panel is connected to the head unit by a cable for receiving analog audio/video signals, such as NTSC or PAL, from the head unit for output.

During installation of a convention vehicle audio/video playback system, a complicated wiring is necessary. In consequence, the installation of a conventional vehicle audio/video playback system is complicated, wasting much time and labor. To eliminate this problem, Taiwan Patent No. 1271333 disclosed a measure entitled “Vehicle wireless digital audio/video system and method”. This vehicle wireless digital audio/video system comprises an audio/video head unit having built therein a storage device, at least one digital audio/video file stored in the storage device and a wireless network interface, and at least one display device each having a wireless network interface and a display screen. By means of the wireless network interface of the display device, the display device can receive the digital audio/video file from the head unit and play the digital audio/video file.

However, the aforesaid prior art design is a one-to-one system, having a narrow range of application.

### SUMMARY OF THE INVENTION

The present invention has been accomplished under the circumstances in view. It is main object of the present invention to provide a wireless vehicle audio/video system, which eliminates complicated vehicle internal wiring, facilitates system installation, and provides a wide range of application.

To achieve this and other objects of the present invention, a wireless vehicle audio/video system comprises a head unit installed in a car and electrically coupled with a computer control system of the car by a controller area network bus for converting control data provided by the car into images/digital data and having built therein a first wireless communication module and a multimedia processing device adapted for processing audio/video and image data from different sources, at least one tablet computer each comprising a touch panel and a built-in second wireless communication module for communication with the first wireless communication module of the head unit wirelessly for transmitting audio-video data, and a car speaker system installed in the car at a selected location and electrically connected to the head unit. Further, each tablet computer is operable to provide a command to the head unit wirelessly for driving the multimedia processing device of the head unit to run an audio-video data, enabling the generated image data to be transmitted wirelessly to the touch screens of the tablet computers for playing and the generated audio signal to be outputted through the car speaker system.

Further, the first wireless communication module of the head unit and the second wireless communication module of each tablet computer can be Wi-Fi modules. Further, the second wireless communication module of each tablet computer and the first wireless communication module of the head unit are adapted for transmitting audio-video data therebetween wirelessly by means of RTP (real-time transport protocol).

Further, the multimedia processing device of said head unit is adapted for processing CD, DVD, SD/USB audio and video files, DVB-T and FM/AM broadcasting signals.

Further, the head unit further comprises a GPS sensor and an AUX-in, and has a rear-view camera and a digital video recorder electrically connected thereto.

Further, each tablet computer provides a Bluetooth function for communication with an external Bluetooth device and has built therein a GPS module.

The wireless vehicle audio/video system of the present invention uses a wireless signal to connect the head unit and the tablet computers, eliminating complicated wiring in the car and facilitating system installation. Further, the tablet computers can be individually carried out of the car for use as individual computers. Thus, the invention involves an inventive step.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 illustrates the system architecture of a wireless vehicle audio/video system in accordance with the present invention.

FIG. 2 explains the operation principle of the wireless vehicle audio/video system in accordance with the present invention.

FIG. 3 illustrates the navigation function of the wireless vehicle audio/video system in accordance with the present invention.

### DETAILED DESCRIPTION OF THE PREFERRED EMBODIMENT

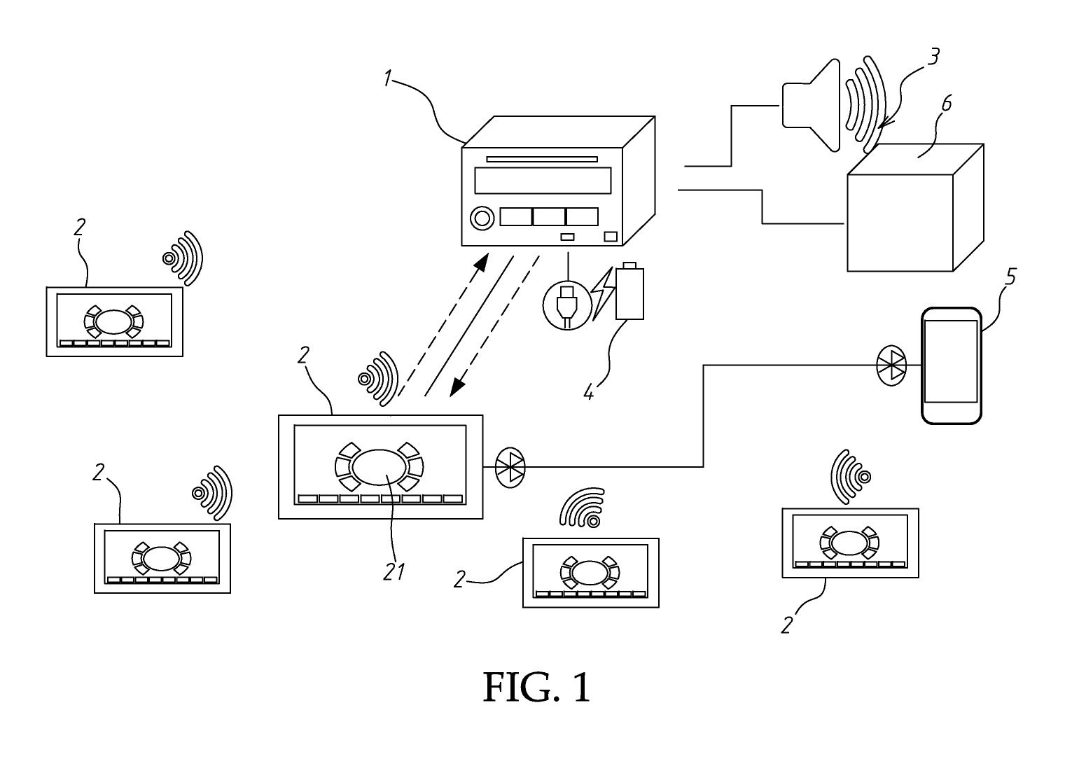

Referring to FIG. 1, a wireless vehicle audio/video system in accordance with the present invention generally comprises a head unit 1, a plurality of tablets computers 2, a car speaker system 3, a charging device 4 and a Bluetooth device 5.

The wireless vehicle audio/video system is installed in a car. The computer control system of the car is electrically coupled with the head unit 1 by a CAN Bus (Controller Area Network Bus) 6 to that control data provided by the car can be converted into images or digital data by the head unit 1 and then wirelessly transmitted by the head unit 1 to the tablet computer 2 for display or control. By means of a Wi-Fi transmission system, the head unit 1 controls the multiple tablet computers 2 to work as display and control terminals, constituting an information sharing system.

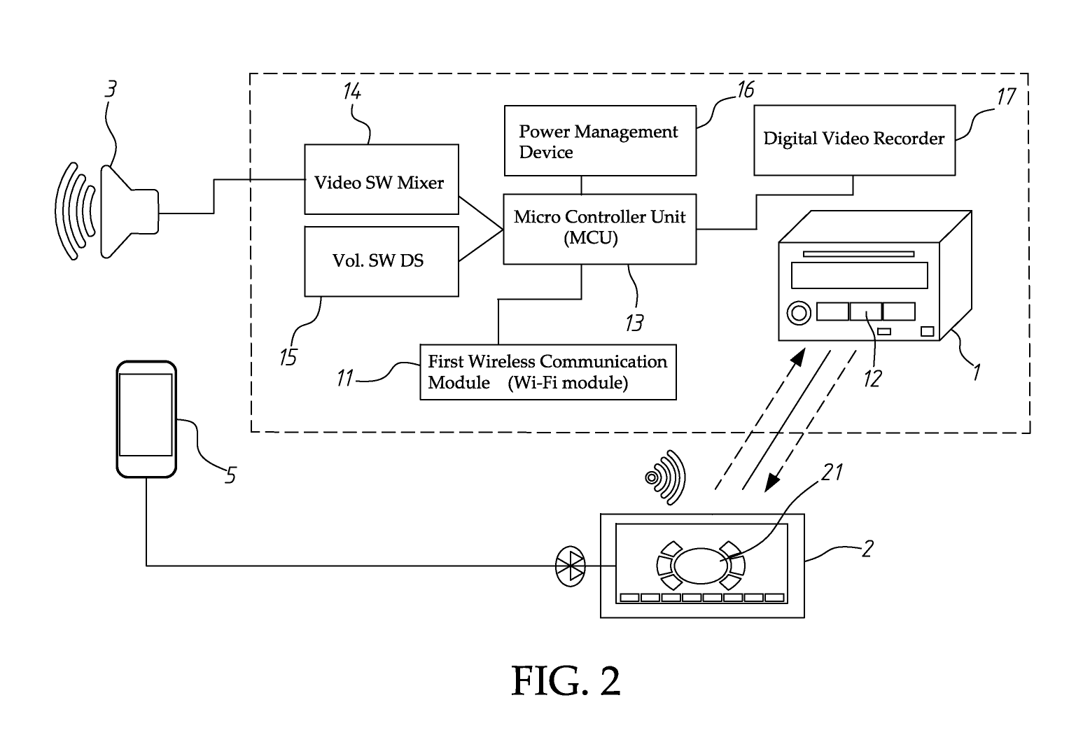

Referring to FIG. 2, the head unit 1 is installed in a car, comprising a first wireless communication module 11 and a multimedia processing device. The first wireless communication module 11 is a Wi-Fi module. The multimedia processing device is adapted for processing audio/video and image data from different sources. The multimedia processing device can process CD, DVD, SD or USB audio and video files, DVB-T and FM/AM broadcasting signals. Further, the head unit 1 can be equipped with a GPS sensor, rear-view camera, and/or AUX-In.

The head unit 1 shown in FIG. 2 further comprises a user interface 12 located on the outside and providing a plurality of operating buttons, a volume control, a radio frequency control and/or other function control members for operation by a user, a micro controller unit 13 having built therein a control program and electrically connected to the first wireless communication module 11, a video SW mixer 14, a Vol. SW DS 15 and a power management device 16. The video SW mixer 14 controls images. The Vol. SW DS 15 controls the car speaker system. The power management device 16 obtains electric power from the power supply system of the car. The head unit 1 can be further equipped with a digital video recorder 17.

Further, the head unit 1 controls multiple tablet computers 2. One tablet computer 2 can be set to be the main control. Each tablet computer comprises a touch panel 21 and a built-in second wireless communication module for communication with the first wireless communication module 11 of the head unit 1 wirelessly for transmitting audio-video data by means of RTP (real-time transport protocol). The car speaker system 3 is installed in the car at a selected location and electrically connected to the head unit 1. Further, the car speaker system 3 provides a wireless transmission function.

The touch panel 21 of each tablet computer 2 is operable to produce a command for wireless transmission to the head unit 1 for driving the multimedia processing device of the head unit 1 to run one audio-video data, enabling the generated image data to be transmitted wirelessly to the touch panels 21 of the tablet computers 2 for playing and the generated sound to be outputted through the car speaker system 3.

The tablet computers 2 can be equipped with a 3.5G/4G wireless telephone and modem system for performing in-vehicle cloud-based vehicle tracking and fleet management and dispatch management. The built-in GPS of this 3.5G/4G wireless telephone and modem system provides vehicle-related traveling position, data filing or report.

Further, the charging device 4 is electrically connectable to each tablet computer 2 by a USB cable to charge the internal battery of the tablet computer 2.

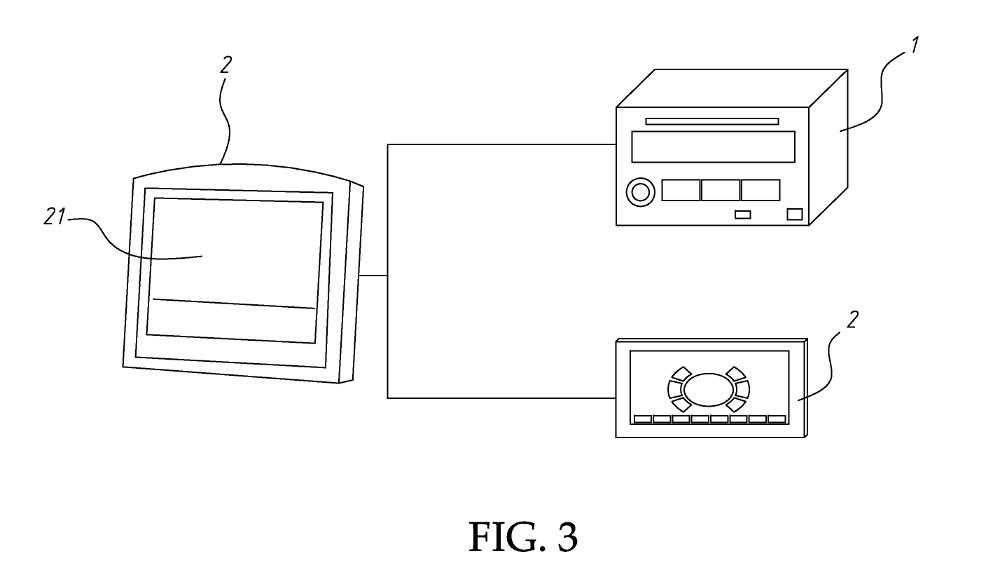

Further, each tablet computer 2 provides a Bluetooth function, allowing communication with a Bluetooth device 5. Referring to FIG. 3, each tablet computer 2 can be equipped with a GPS module that can use the GPS antenna module in the head unit 1 to provide a navigation function.

The following table discloses the various operation signal sources of the wireless vehicle audio/video system for different functions:

| Transmission mode | Application range |
|---|---|
| (PAD) → (Command) → (Head Unit) | DVD, Digital TV |
| (Head Unit) → (RTP (Video)) →(PAD) | |
| (Head Unit) → (Command) →(PAD), | Parking aid and other |
| (Head Unit) → (RTP (Video)) → (PAD) | functions |
| (PAD) → (Command) → (Head Unit) | FM/AM, CD play |
| PAD integrates all songs (sources including PAD, | MP3 |
| Head Unit-USB/SD) | |
| 1. Play song from PAD: | |
| (PAD) → (Command) → (Head Unit), | |
| (PAD) → (RTP (Audio)) → (Head Unit) | |
| 2. Play sound from Head Unit: | |
| (PAD) → (Command) → (Head Unit) | |
| PAD integrates all Videos (including PAD, Head | Video |
| Unit-USB/SD) | |
| (PAD) → (Command) → (Head Unit) | |
| (Head Unit) → (RTP (Video)) → (PAD) | |
| (PAD) → (Command) → (Head Unit) | GPS |
| (PAD) → (RTP (Audio)) → (Head Unit) | |
| (Bluetooth Device→(PAD) →(Command) → | Bluetooth Device |
| (Head Unit), | |
| (PAD) → (RTP (Audio)) → (Head Unit) | |
| (or) | |
| (Head Unit) → (RTP (Video)) →(PAD) | |

Obviously, the wireless vehicle audio/video system of the present invention uses a wireless signal to connect the head unit 1 and the tablet computers 2, eliminating complicated wiring in the car and facilitating system installation. Further, the tablet computers 2 can be individually carried out of the car for use as individual computers. When compared to conventional vehicle audio/video systems, the invention involves an inventive step.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A wireless vehicle audio/video system, comprising:
a head unit installed in a car and electrically coupled with a computer control system of said car by a controller area network bus for converting control data provided by said car into images/digital data, said head unit comprising a first wireless communication module and a multimedia processing device, said multimedia processing device being adapted for processing audio/video and image data from different sources'
at least one tablet computer each comprising a touch panel and a built-in second wireless communication module for communication with said first wireless communication module of said head unit wirelessly for transmitting audio-video data;
a car speaker system installed in said car at a selected location and electrically connected to said head unit;
wherein each said tablet computer is operable to produce a command for wireless transmission to said head unit for driving the multimedia processing device of said head unit to run an audio-video data, enabling the generated image data to be transmitted wirelessly to the touch screens of said tablet computers for playing and the generated audio signal to be outputted through said car speaker system.

2. The wireless vehicle audio/video system as claimed in claim 1, wherein the first wireless communication module of said head unit and the second wireless communication module of each said tablet computer are Wi-Fi modules.

3. The wireless vehicle audio/video system as claimed in claim 1, wherein the second wireless communication module of each said tablet computer and the first wireless communication module of said head unit are adapted for transmitting audio-video data therebetween wirelessly by means of RTP (real-time transport protocol).

4. The wireless vehicle audio/video system as claimed in claim 1, further comprising a charging device electrically connectable to each said tablet computer by a USB cable to charge an internal battery of the tablet computer.

5. The wireless vehicle audio/video system as claimed in claim 1, wherein the multimedia processing device of said head unit is adapted for processing CD, DVD, SD/USB audio and video files.

6. The wireless vehicle audio/video system as claimed in claim 1, wherein the multimedia processing device of said head unit is capable of processing DVB-T signals.

7. The wireless vehicle audio/video system as claimed in claim 1, wherein said head unit comprises a GPS sensor.

8. The wireless vehicle audio/video system as claimed in claim 1, wherein the multimedia processing device of said head unit is capable of processing FM/AM broadcasting signals.

9. The wireless vehicle audio/video system as claimed in claim 1, wherein said head unit has a rear-view camera electrically connected thereto.

10. The wireless vehicle audio/video system as claimed in claim 1, wherein said head unit has a digital video recorder electrically connected thereto.

11. The wireless vehicle audio/video system as claimed in claim 1, wherein said head unit further comprises an AUX-in.

12. The wireless vehicle audio/video system as claimed in claim 1, wherein each said tablet computer has a Bluetooth function for communication with an external Bluetooth device.

13. The wireless vehicle audio/video system as claimed in claim 1, wherein said head unit comprises a GPS module.

14. The wireless vehicle audio/video system as claimed in claim 1, wherein each said tablet computer is equipped with a 3.5G/4G wireless telephone and modem system for performing in-vehicle cloud-based vehicle tracking and fleet management and dispatch management, said built-in GPS of this 3.5G/4G wireless telephone and modem system being adapted for providing vehicle-related traveling position, data filing or report.

15. The wireless vehicle audio/video system as claimed in claim 1, wherein said head unit comprises:
a user interface disposed on the outside for operation by a user;
a micro controller unit;
a video SW mixer electrically connected to said micro controller unit;
a Vol. SW DS electrically connected to said micro controller unit for controlling said car speaker system; and
a power management device adapted for obtaining electric power from the power supply system of said car.

16. The wireless vehicle audio/video system as claimed in claim 15, wherein said user interface comprises at least one operation button.
